(19) United States
(12) Patent Application Publication
(10) Pub. No.: US 2006/0112240 A1
(43) Pub. Date: May 25, 2006

(54) Priority scheme for executing commands in memories

(76) Inventors: Robert Michael Walker, Raleigh, NC (US); Perry Willmann Remaklus JR., Raleigh, NC (US)

Correspondence Address: QUALCOMM, INC, 5775 MOREHOUSE DR., SAN DIEGO, CA, 92121, US

(21) Appl. No.: 10/997,542

(22) Filed: Nov. 24, 2004

(51) Int. Cl. G06F 13/00

(52) U.S. Cl. 711/154

(57) ABSTRACT

A command execution priority scheme for memories is disclosed. The priority scheme is directed to systems and techniques for storing and retrieving data from memory. A command queue may be used to receive a plurality of commands, each of the commands requesting access to the memory. A command selector may be used to evaluate a block the of the commands in the command queue to select one of the commands from the block to execute, and execute the selected command.

### BACKGROUND

1. Field

The present disclosure relates generally to memories, and more specifically, to a command execution priority scheme for memories.

2. Background

Memories are used extensively today in digital systems to store data needed by various processing entities. Most memories are internally structured with a number of memory banks. Each memory bank may be addressed individually as an array of rows and columns. This means that the various processing entities can access data from each memory bank in parallel by issuing the appropriate read or write command.

A memory controller may be used to manage access to the memory banks by the various processing entities. The memory controller receives read and write commands into a command queue, and executes the commands in the order they are received. The delay associated with the execution of each command depends on whether an open page in a memory bank is being accessed. A “page” is normally associated with a row of memory, and an “open page” means that the memory bank is pointing to a row of memory and requires only a column address strobe from the memory controller to access the memory location. To access an unopened page of a memory bank, the memory controller must present a row address strobe to the memory bank to move the pointer before presenting a column address strobe. As a result, the latency of the system may be adversely impacted every time a new page is accessed in a memory bank.

In addition to the latency, a large amount of power may be required to open a new page in a memory bank. This may be of paramount concern in battery operated devices, such as cellular and wireless telephones, laptops, personal digital assistants (PDA), and the like. If the sequence of commands from the various processing entities cause an excessive amount of pages in a memory bank to be opened and closed, then the life of the battery may be substantially reduced.

### SUMMARY

In one aspect of the present invention, a method of storing and retrieving data from memory includes receiving a plurality of commands into a command queue, each of the commands requesting access to the memory, evaluating a block of the commands in the command queue to select one of the commands from the block to execute, and executing the selected command.

In another aspect of the present invention, a memory system includes memory, a command queue configured to receive a plurality of commands, each of the commands requesting access to the memory, and a command selector configured to evaluate a block of the commands in the command queue to select one of the commands from the block to execute, and to execute the selected command.

In yet another aspect of the present invention, a memory system includes memory, a command queue configured to receive a plurality of commands, each of the commands requesting access to the memory, means for evaluating a block of the commands in the command queue to select one of the commands from the block to execute, and means for executing the selected command.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

FIG. 1 is a conceptual block diagram illustrating an example of a memory system;

FIG. 2 is a conceptual block diagram illustrating another example of a memory system;

FIG. 3 is a conceptual block diagram illustrating an example of a memory system with detail of the memory controller;

FIG. 4 is a flow diagram illustrating an example of an algorithm employed by a memory controller to access memory in a memory system;

FIG. 5 is a flow diagram illustrating an example of the algorithm of FIG. 4 programmed to eliminate the priority given to one type of command for accessing memory; and

FIG. 6 is a flow diagram illustrating an example of the algorithm of FIG. 4 programmed to eliminate the priority given to another type of command for accessing memory.

### DETAILED DESCRIPTION

The detailed description set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

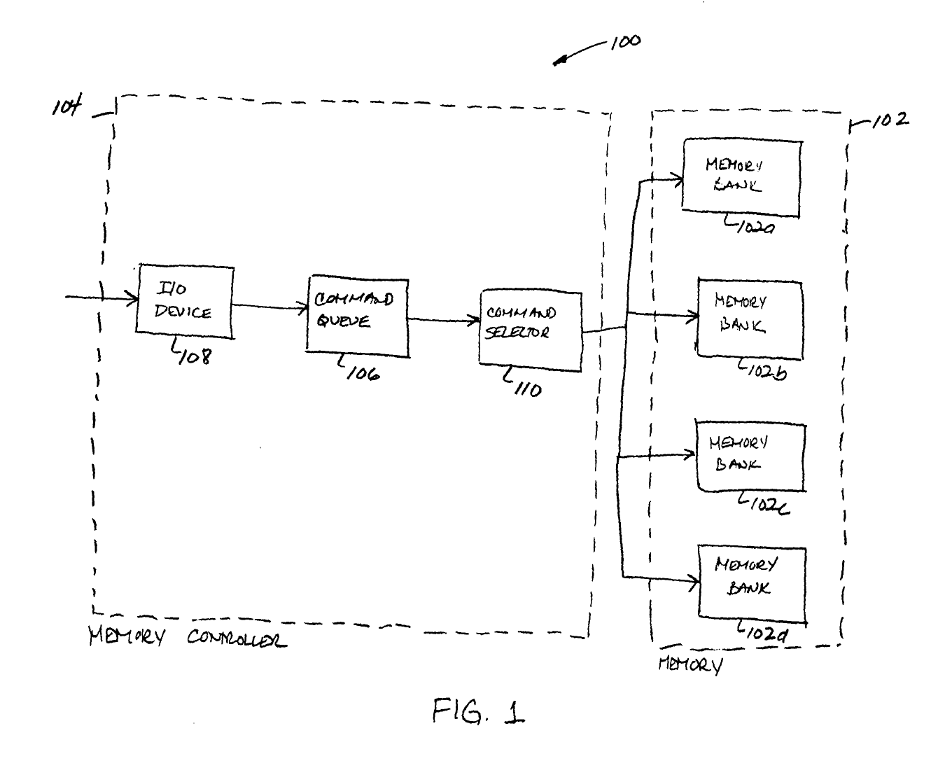

FIG. 1 is a conceptual block diagram illustrating an example of a memory system. The memory system 100 may include memory 102, which is shown with four banks 102a-102d, but may have any number of banks depending on the particular application and overall design constraints. The memory 102 may be a Synchronous Dynamic Random Access Memory (SDRAM), or any other type of memory.

A memory controller 104 may be used to manage access to the memory banks 102a-102d by various processing entities (not shown). The memory controller 104 may include a command queue 106 to buffer the commands from the processing entities. Although not shown, the memory controller 106 may also include a data queue for storing and retrieving data to and from the memory banks. An input/output (I/O) device 108 may provide an interface to a bus, or any other communication medium. A command selector 110, or any other type of processing element, may be used to execute the commands from the command queue 106 to access the memory banks 102a-102d.

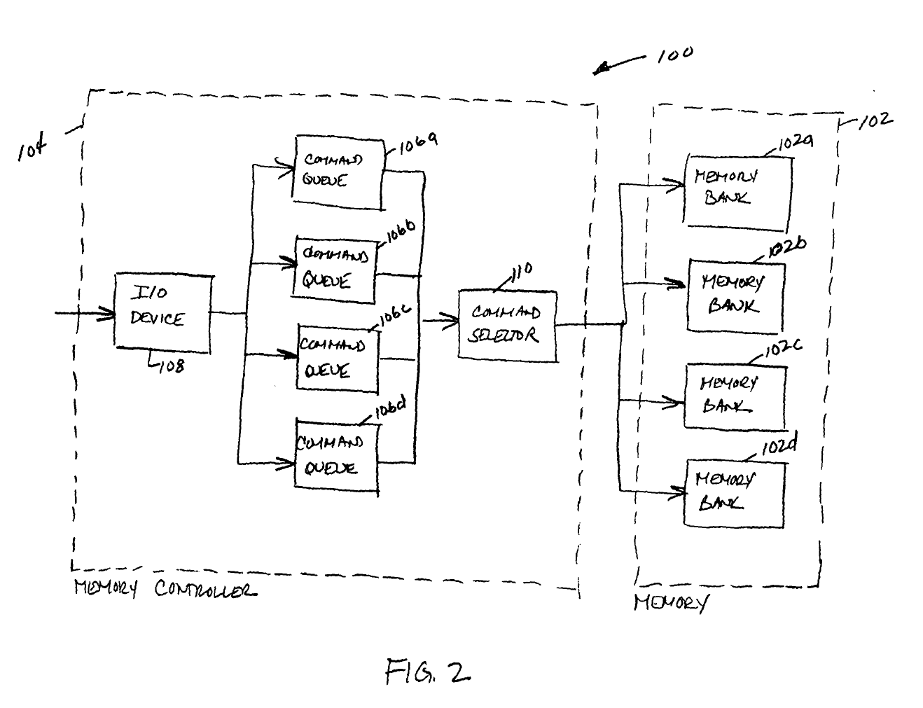

FIG. 2 is a conceptual block diagram illustrating another example of a memory system. In this embodiment, the memory controller 104 may include a separate command queue for each memory bank, and in this case, the memory controller 104 includes four command queues 106a-106d. The I/O device 108, in addition to providing an interface to the communication medium, may be used to determine the destination memory bank for each command received from the communication medium, and store that command in the appropriate command queue.

A reduction in latency and power consumption may be achieved by reordering the commands received by the memory controller 104 to minimize the number of times that pages are opened and closed in the memory 102. For the purposes of illustration, various techniques for reducing latency and power consumption will be described in the context of a memory system having a separate command queue for each memory bank with the understanding that these techniques may be extended to a memory system with a single command queue supporting one or more memory banks.

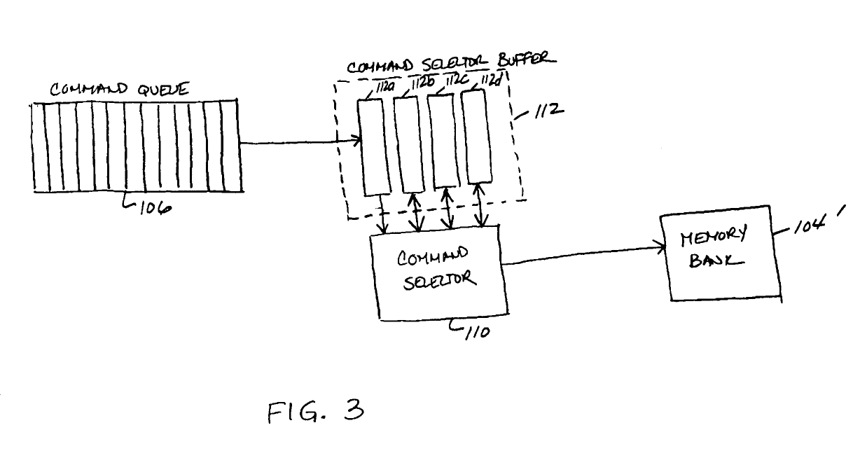

FIG. 3 is a conceptual block diagram illustrating an example of a memory system in which the commands received by a command queue 106 for one of the memory banks 104′ may be reordered to reduce latency and power consumption. In this configuration, the commands may be reordered independent of the commands for the other memory banks. The command queue 106 may be a first-in-first out (FIFO) memory, or any other type of storage device. A command selector buffer 112 may be disposed between the command queue 106 and the command selector 110. The command selector buffer 112 may be configured with four independent registers 112a-112d, although it may be configured with any number of registers depending on the design preferences of the skilled artisan, the particular application of the memory system, and the overall design constraints. The command queue 106 may be configured to load commands into an input register 112a, and the command selector 110 may be configured to retrieve commands from the input register 112a. The command selector 110 may also have exclusive access to the remaining three hold registers 112b-112d.

In operation, the command selector 110 retrieves the commands from the four registers 112a-112b in the command selector buffer 112, and selects one of the four commands to execute. The command selector 110 makes this selection based on a control algorithm designed to reduce latency and power consumption by minimizing the number of times that pages are opened and closed in the corresponding memory bank 104′. Once the command selector 110 makes a selection, it executes the selected command, resulting in a read or write operation to the memory bank 104′. The three unselected commands are loaded back into the hold registers 112b-112d, and a new command from the command queue 106 is loaded into the input register 112a. The process may then be repeated.

An example of a control algorithm that may be implemented by the command selector 110 will now be described with the understanding that the command selector 110 may implement various other algorithms that fall within the scope of the present invention. The control algorithm may be applied to a command queue capable of supporting a single memory bank, or alternatively, an entire memory device. The entire device may be constructed with one or more memory banks.

In one embodiment, the control algorithm may be configured to select a command from the command selector buffer 112 to an open page in the memory before selecting a command to an unopened page. Multiple commands to an open page in the memory may be reordered to perform read operations before write operations as long as the commands are from different processing entities. If a read and write operation is issued by the same processing entity, it may be important to maintain the sequence of the commands. A source identifier may be included in command so that the memory controller 110 can determine whether multiple commands are from the same processing entity. If there are no commands in the command selector buffer 112 to an open page in the memory, then a command to an unopened page in the memory may be executed. A read operation may be given priority over a write operation.

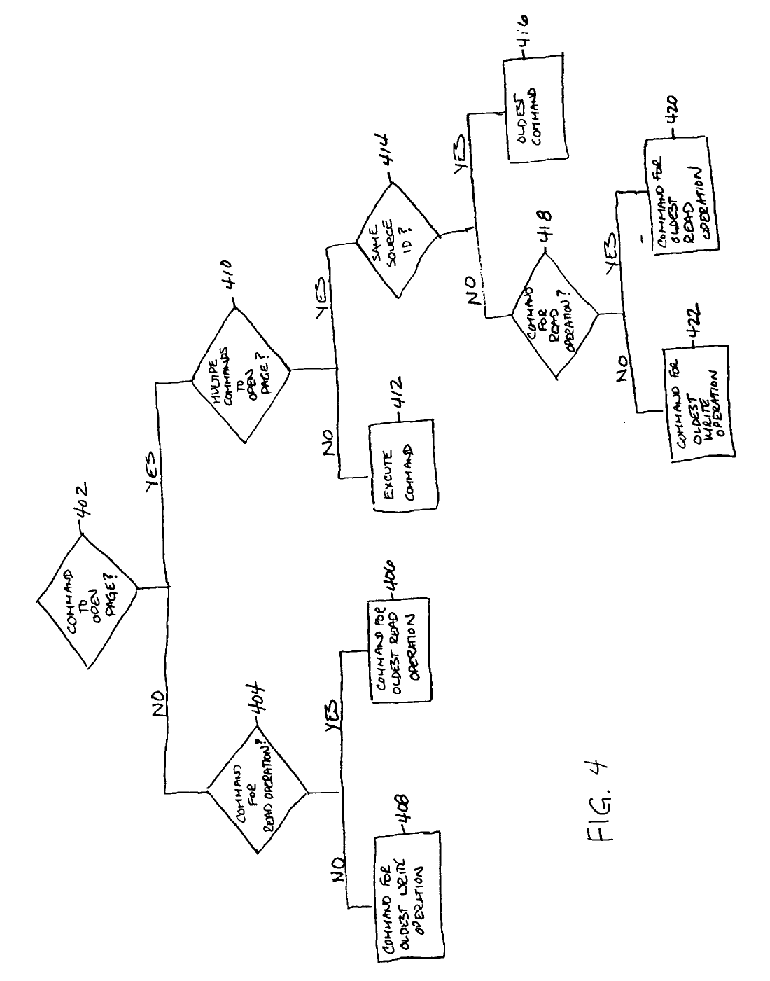

An example of this control algorithm is illustrated in the flow diagram of FIG. 4. In block 402, the control algorithm may determine whether there are any commands in the command selector buffer to an open page in the memory. If all the commands in the command selector buffer are to unopened pages in the memory, then the control algorithm may determine whether there are any commands in command selector buffer for a read operation in block 404. If there are one or more commands in the command selector buffer for a read operation, the control algorithm may select the oldest one to execute in block 406. Otherwise, the control algorithm may select the oldest write operation command to execute in block 408.

Returning to block 402, if the control algorithm determines that there are one or more commands in the command selector buffer to an open page in the memory, the control algorithm may then determine, in block 410, whether there are more than one. If there is only one command in the command selector buffer to an open page in the memory, then the control algorithm may select that command to be executed in block 412. If, on the other hand, the control algorithm determines that there are more than one, then the source identifier for each may be checked, in block 414, to determine whether there are multiple commands from the same processing entity. If there are, the control algorithm may execute the oldest command to an open page in the memory in block 416. Otherwise, the control algorithm may determine, in block 418, whether there are any commands in the command selector buffer for a read operation to an open page in the memory. If so, the control algorithm may execute the oldest one in block 420. Otherwise, the control algorithm may execute the oldest write operation command in the command selector buffer to an open page in the memory in block 422.

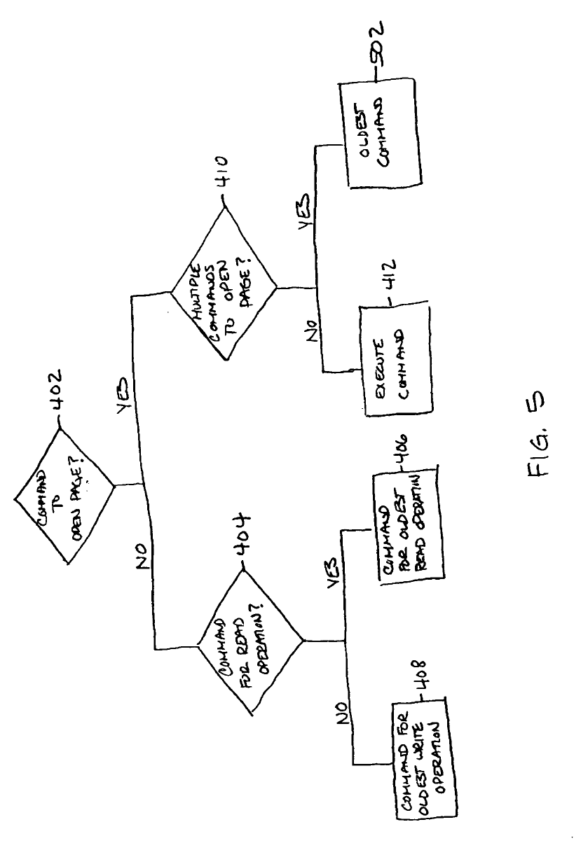

As can be seen from FIG. 4, priority is given to various types of commands throughout the execution of the control algorithm by the command selector. By way of example, priority may be given to a command to an open page of memory rather than a closed page. For any given page in the memory, priority may be given to a command for a read operation over a write operation. In at least one embodiment of the memory controller, one or more priorities implemented in the algorithm may be enabled or disabled with programmable data in a control register. By way of example, the priority for a read operation over a write operation among multiple commands to an open page in the memory from the same processing entity may be disabled as shown in FIG. 5. Referring to FIG. 5, if the control algorithm determines that there are no commands in the command selector buffer to an open page in the memory in block 402, then the selection process remains unchanged. The same is true if the selection algorithm determines, in blocks 402 and 410, that there is one, and only one, command in the command selector buffer to an open page in the memory. However, if the control algorithm determines, in blocks 402 and 410, that there are multiple commands in the command selector buffer to an open page opened in the memory, then the algorithm may simply chose the oldest one to execute in step 502, rather than giving priority to read operations.

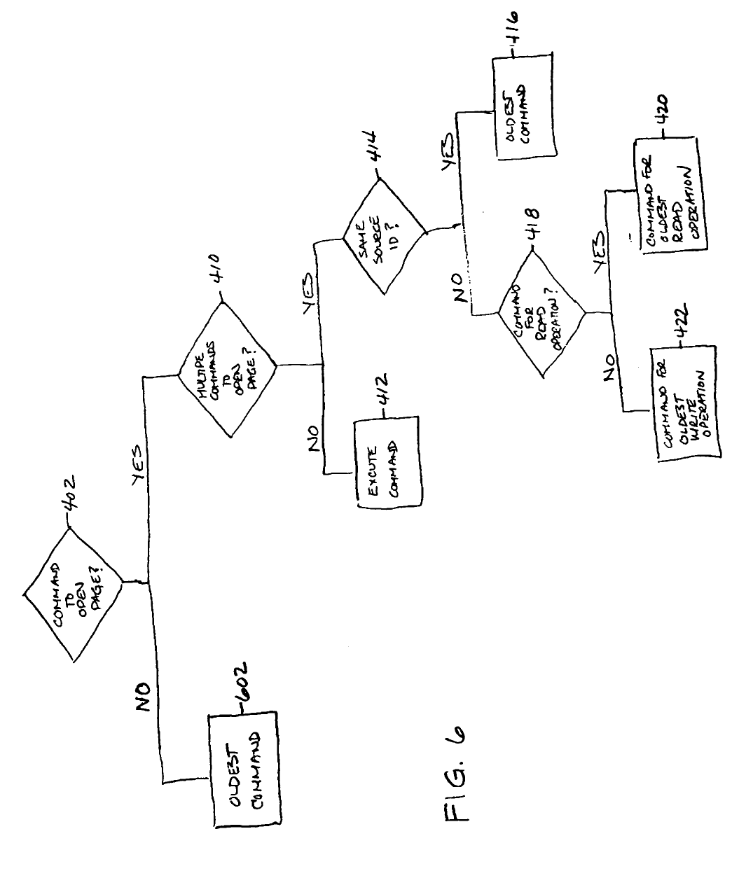

Alternatively, the priority of a read operation over a write operation may be disabled when all the commands in the command selector buffer are to an unopened page in the memory as shown in FIG. 6. If the control algorithm determines that there is at least one command in the command selector buffer to an open page in the memory in block 402, then the selection process remains unchanged. However, if the control algorithm determines, in block 402, that there are no commands in the command selector buffer to an open page in the memory, then the algorithm may simply chose the oldest command in the command selector buffer to execute in step 602, rather than giving priority to read operations.

The various illustrative logical blocks, modules, circuits, elements, and/or components described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of storing and retrieving data from memory, comprising:
receiving a plurality of commands into a command queue, each of the commands requesting access to the memory;
evaluating a block the of the commands in the command queue to select one of the commands from the block to execute; and
executing the selected command.

2. The method of claim 1 wherein the selected command requests access to an open page in the memory.

3. The method of claim 1 further comprising executing the remaining commands in the block following the selected command, the remaining commands in the block that request access to an open page in the memory being executed before the remaining commands in the block that request access to an unopened page in the memory.

4. The method of claim 1 wherein the commands in the block are the oldest commands from the command queue.

5. The method of claim 1 wherein the block of the commands is evaluated by identifying all of the commands in the block requesting access to an open page in the memory, and wherein the selected command comprises one of the identified commands.

6. The method of claim 5 wherein the identified commands comprise at least two commands from the block of the commands, and wherein the selected command comprises the oldest one of the identified commands.

7. The method of claim 5 wherein the block of the commands is further evaluated by determining that at least two of the identified commands are from the same processing entity, and wherein the selected command comprises the oldest one of the identified commands in response to such determination.

8. The method of claim 5 wherein the block of the commands is further evaluated by determining that none of the identified commands are from the same processing entity, and that at least one of the identified commands requests access to the memory to perform a read operation, and wherein the selected command comprises the oldest one of the identified commands requesting access to the memory to perform the read operation.

9. The method of claim 5 wherein the block of the commands is further evaluated by determining that none of the identified commands are from the same processing entity, and that all of the identified commands request access to the memory to perform a write operation, and wherein the selected command comprises the oldest one of the identified commands requesting access to the memory to perform the write operation.

10. The method of claim 1 wherein the block of the commands is evaluated by determining that all of the commands in the block request access to an unopened page in the memory, and wherein the selected command comprises the oldest one of the commands in the block.

11. The method of claim 1 wherein the block of the commands is evaluated by determining that all of the commands in the block request access to an unopened page in the memory, and at least one of the commands in the block requests access to the memory to perform a read operation, and wherein the selected command comprises the oldest one of the commands in the block requesting access to the memory to perform the read operation.

12. The method of claim 1 wherein the block of the commands is evaluated by determining that all of the commands in the block request access to an unopened page in the memory, and that all the commands in the block request access to the memory to perform a write operation, and wherein the selected command comprises the oldest one of the commands in the block.

13. A memory system, comprising:
memory;
a command queue configured to receive a plurality of commands, each of the commands requesting access to the memory; and
a command selector configured to evaluate a block the of the commands in the command queue to select one of the commands from the block to execute, and to execute the selected command.

14. The memory system of claim 13 wherein the selected command requests access to an open page in the memory.

15. The memory system of claim 13 wherein the command selector is further configured to execute the remaining commands in the block following the selected command, the remaining commands in the block that request access to an open page in the memory being executed before the remaining commands in the block that request access to an unopened page in the memory.

16. The memory system of claim 13 wherein the commands in the block are the oldest commands from the command queue.

17. The memory system of claim 13 wherein the command selector is further configured to evaluate the block of the commands by identifying all of the commands in the block requesting access to an open page in the memory, and wherein the selected command comprises one of the identified commands.

18. The memory system of claim 17 wherein the command selector is further configured to determine whether the identified commands comprise at least two commands from the block of the commands, and wherein the selected command comprises the oldest one of the identified commands if the command selector makes such determination.

19. The memory system of claim 17 wherein the command selector is further configured to evaluate the block of the commands by determining whether at least two of the identified commands are from the same processing entity, and wherein the selected command comprises the oldest one of the identified commands if the command selector makes such determination.

20. The memory system of claim 17 wherein the command selector is further configured to evaluate the block of the commands by determining whether each of the identified commands are from different processing entities, and whether at least one of the identified commands requests access to the memory to perform a read operation, and wherein the selected command comprises the oldest one of the identified commands requesting access to the memory to perform the read operation if both such determinations are made.

21. The memory system of claim 17 wherein the command selector is further configured to evaluate the block of the commands by determining whether each of the identified commands are from different processing entities, and whether all of the identified commands request access to the memory to perform a write operation, and wherein the selected command comprises the oldest one of the identified commands requesting access to the memory to perform the write operation if both such determinations are made.

22. The memory system of claim 13 wherein the command selector is further configured to evaluate the block of commands by determining whether all of the commands in the block request access to an unopened page in the memory, and wherein the selected command comprises the oldest one of the commands in the block if such determination is made.

23. The memory system of claim 13 wherein the command selector is further configured to evaluate the block of the commands by determining whether all of the commands in the block request access to an unopened page in the memory, and whether at least one of the commands in the block requests access to the memory to perform a read operation, and wherein the selected command comprises the oldest one of the commands in the block requesting access to the memory to perform the read operation if such determination is made.

24. The memory system of claim 13 wherein the command selector is further configured to evaluate the block of the commands by determining whether all of the commands in the block request access to an unopened page in the memory, and whether all the commands in the block request access to the memory to perform a write operation, and wherein the selected command comprises the oldest one of the commands in the block if both such determinations are made.

25. The memory system of claim 14 wherein the memory comprises a SDRAM.

26. A memory system, comprising:
memory;
a command queue configured to receive a plurality of commands, each of the commands requesting access to the memory;
a command selector comprising means for evaluating a block the of the commands in the command queue to select one of the commands from the block to execute, and means for executing the selected command.

27. The memory system of claim 26 wherein the selected command requests access to an open page in the memory.

28. The memory system of claim 26 wherein the means for executing the selected command executes the remaining commands in the block following the selected command, the remaining commands in the block that request access to an open page in the memory being executed before the remaining commands in the block that request access to an unopened page in the memory.
